(19) United States
(12) Patent Application Publication
(10) Pub. No.: US 2014/0356470 A1
(43) Pub. Date: Dec. 4, 2014

(54) Adjustment Assembly, Load Assembly Comprising Same, Press System Comprising Same and Method of Adapting Load Assembly

(71) Applicant: ELEMENT SIX ABRASIVES S.A., LUXEMBOURG (LU)

(72) Inventor: Dragan Vukovic, Didcot (ZA)

(73) Assignee: ELEMENT SIX ABRASIVES S.A., LUXEMBOURG (LU)

(21) Appl. No.: 14/362,617

(22) PCT Filed: Dec. 5, 2012
(86) PCT No.: PCT/EP2012/074529

§ 371 Date: Jun. 4, 2014

Related U.S. Application Data
(60) Provisional application No. 61/569,198, filed on Dec. 9, 2011.

(30) Foreign Application Priority Data
Dec. 9, 2011 (GB) 1121181.0

(51) Int. Cl. B01J 3/06

(52) U.S. Cl. CPC B01J 3/065
USPC 425/77

(57) ABSTRACT

An adjustment assembly comprising a platform (110) moveably coupled to a base (120), and an adjustment mechanism comprising a deflection member (132, 134) for adjusting the position of the platform (110) laterally relative to the base (120); the adjustment assembly being configured so that the platform (110) can be urged to move laterally in a direction along a first axis responsive to the deflection member (132, 134) being urged to move in a direction along a second axis, the second axis being substantially not parallel to the first direction.

This disclosure relates generally to an adjustment assembly, a load generator assembly comprising same, a press system comprising same and a method of adapting a load assembly to include same. The disclosure relates particularly but not exclusively to an adjustment assembly for use in a press system for generating ultra-high pressure.

Press systems capable of generating ultra-high pressures of at least about 3 GPa and temperatures of at least about 1,000 degrees centigrade within a reaction vessel can be used for manufacturing diamond and cubic boron nitride (cBN) materials. The reaction vessel may contain raw materials for the diamond or cBN material. A press system may comprise at least two anvils which can be urged against the reaction vessel from different directions with an applied force to subject the reaction vessel to a pressure. The reaction vessel may be heated by means of an electric current that may be passed through the anvils and through the reaction vessel itself.

In a belt type press system, two opposing anvils are urged against a reaction volume located between them and contained laterally by an annular containment means (a “belt”). Other examples of press systems include tetrahedral and cubic presses, which comprise four and six anvils, respectively. The movement of each anvil may be controlled by means of a respective hydraulic mechanism, which may be capable of driving the anvil with great force. The hydraulic mechanism may comprise a hydraulic cylinder, a piston and a ram. Each anvil may be mounted onto an anvil holder, which may be disposed against a bolster block located between the anvil holder and the ram. The hydraulic cylinder may be actuated to move the ram longitudinally forward against the bolster block and consequently to move the anvil forward. The hydraulic cylinder will generally be connected to a press frame so that the anvil can be forced to move relative to the press frame along a longitudinal axis defined by the load assembly. A reaction vessel will generally be located between opposing anvils within a volume defined by the press frame and it is generally important to be able to align each anvil laterally and rotationally about the longitudinal axis of movement.

Certain commercially available cubic press systems suitable for synthesising diamond comprise at six hydraulically operated load assemblies. Each anvil may be held laterally in place by a plurality of bolts impinging on the anvil holder and the anvils may be aligned by loosening the bolts and manually moving the anvil holder against the bolster block. The anvil holder may be translated and or rotated, although it tends to be difficult to align the anvil in one direction without also moving it in another direction or rotating it at the same time. In other words, it can be difficult to de-couple the various axes of alignment in practice.

U.S. Pat. No. 7,481,639 discloses a cartridge assembly for connection to the frame of a high pressure high temperature press, comprising a front end that may further comprise a back-up intermediate coaxial with an anvil and a piston. The anvil may comprise a proximal end in contact with the back-up and a distal end may be adapted to form part of a pressurized chamber within the frame of the press. A front end may comprise a centering assembly that may be encompassed by a key ring, which may comprise a plurality of receptacles for receiving a plurality of locking pins that may be adapted to centre the centering assembly. In other embodiments locking pins may also be adapted to centre the anvil. In some embodiments the ability to ensure that the anvils are substantially aligned within the pressurized chamber may assist to provide proper sealing between anvils and substantially reduce the probability of shoulder loading and or stress fractures.

Viewed from a first aspect there is provided an adjustment assembly comprising a platform moveably coupled to a base, and an adjustment mechanism comprising a deflection member for adjusting the lateral position of the platform relative to the base; the adjustment assembly being configured so that the platform is capable of being urged to move laterally in a direction along a first axis responsive to the deflection member being urged to move in a direction along a second axis, the second axis being substantially not parallel to the first direction.

Various arrangements and combinations are envisaged by the disclosure, of which the following are non-limiting and non-exhaustive examples. For example, the first and second axes may be substantially orthogonal to each other. The adjustment mechanism may be configured so that the longitudinal distance between the platform and the base does not substantially change when the platform moves laterally relative to the base along the first axis and or along the second direction. The first and second axes may be substantially parallel to a glide boundary between the platform and the base. The glide boundary may be defined by or located between a glide surface of the platform and a support surface of the base. The glide surface of the platform and the support surface of the base may be substantially planar or include respective regions that are substantially planar. The adjustment assembly may be configured to permit the platform to move along the first and second axes on the same plane substantially parallel to the glide boundary.

At least a part of the deflection member may be generally tapered or wedge-shaped. The deflection member may abut the platform and or the base. Movement of the deflection member may be constrained by a guide means, which may comprise a guide member connected to the base and or the platform. The deflection member may be disposed between the base and a guide member connected to the platform, and or between the platform and a guide member connected to the base. The deflection member may be coupled to an adjustment means for urging the deflection member to move in a direction along the second axis responsive to actuation of the adjustment means. The adjustment means may comprise a threaded member such as a screw or bolt, which may be manually, electrically or mechanically actuated.

The adjustment assembly may comprise a pair of deflection members disposed opposite each other and arranged to cooperate in the adjustment of the position of the platform relative to the base. For example, the deflection members may be cooperatively configured so that actuation of both deflection members to move substantially synchronously in the same direction along the second axis may be operative to urge to platform to move in a direction along the first axis. In an example arrangement, both deflection members may comprise tapered portions and may be arranged in relation to the platform and the base with the taper portions having opposite orientations so that when the platform moves responsive to the movement of one of the deflection members, substantially simultaneous movement of the other deflection member creates space into which the platform can move. In some examples, the deflection member may comprise a taper gib. The movement of the platform along the first axis responsive to movement of the deflection member or members in along the second axis may be constrained by a guide means.

In some example arrangements, the deflection member may be canted at an angle to the support surface, the glide boundary and or the longitudinal axis. For example, the angle may be in the range from about 45 to 65 degrees, or more particularly about 60 degrees. Such an arrangement may have the aspect of making the adjustment mechanism more robust and resistant to sudden and substantial impact, such as may occur in the event of sudden pressure loss within a reaction volume being pressurised by the load assembly.

The adjustment mechanism may comprise a transverse adjustment means for moving the platform relative to the base in a direction along the second axis. The transverse adjustment means may comprise an actuator means. For example, the actuator means may comprise a threaded member such as screw or bolt. In some example arrangements, the deflection member and the transverse adjustment means may be configured such that the platform can be constrained to move along the second axis by the deflection member, responsive to actuation of the transverse adjustment means.

For example, the platform may be capable of being moved in a direction along the first axis by the deflection member or members, and in a direction along the second axis by the transverse adjustment means. The adjustment assembly may be configured so that the lateral position of the platform relative to the base can be adjusted in either direction along each of two orthogonal axes, X and Y, by coordinated operation of a pair of opposed deflection members and a pair of opposed transverse adjustment members.

The adjustment assembly may comprise a superstructure moveably coupled to the platform. For example, the superstructure may be rotatably coupled to the platform by a rotational coupling means for adjusting and securing the rotational position of the superstructure with respect to the platform. In some examples, the superstructure may comprise an anvil assembly for pressurising a reaction capsule with a force.

In some arrangements, the base may be coupled to a thrust means, such as a hydraulically operated mechanism for urging the base (and consequently the platform and, in some examples, the superstructure) to move in a longitudinal direction substantially orthogonal to the first and second lateral axes.

Operation of the alignment mechanism may be manual or mechanised, for example by means of a ball screw.

Disclosed adjustment mechanisms may have the aspect that movement of the platform relative to the base in directions along the first and second axes may be independently effected and controlled. Movement along both axes may be possible on the same plane or surface. In some example arrangements, rotational adjustment of a superstructure coupled to the platform may be effected and controlled independently of lateral translational movement.

Viewed from a second aspect there is provided a load assembly for a press system for generating ultra-high pressure, comprising an adjustment assembly according to this disclosure. The load assembly may comprise an anvil assembly moveably coupled to a base. The anvil assembly may comprise an anvil mounted onto an anvil holder. The anvil assembly may be for a cubic press for generating ultra-high pressure for diamond synthesis and or sintering. The load assembly may comprise a hydraulic cylinder including a ram and an anvil moveably coupled to the ram by means of a adjustment assembly according to this disclosure.

Viewed from a third aspect there is provided a press system for generating ultra-high pressure, comprising at least two load assemblies according to this disclosure, the load assemblies being attached to a press frame and arranged to be capable of cooperatively generating an applied load on a reaction volume.

Viewed from a fourth aspect there is provided a method of adapting a load assembly for a press system, the load assembly comprising an anvil assembly, a hydraulic system and a bolster block; the bolster block being disposed between the anvil assembly and the hydraulic system when assembled as in use; providing an adjustment mechanism configured for coupling with the hydraulic system at one end and the anvil assembly at an opposite end; and replacing the bolster block with the adjustment mechanism. The adjustment mechanism may comprise a material suitable for use in a bolster block, for example hardened and or tempered tool steel.

Example arrangements will be described with reference to the accompanying figures of which

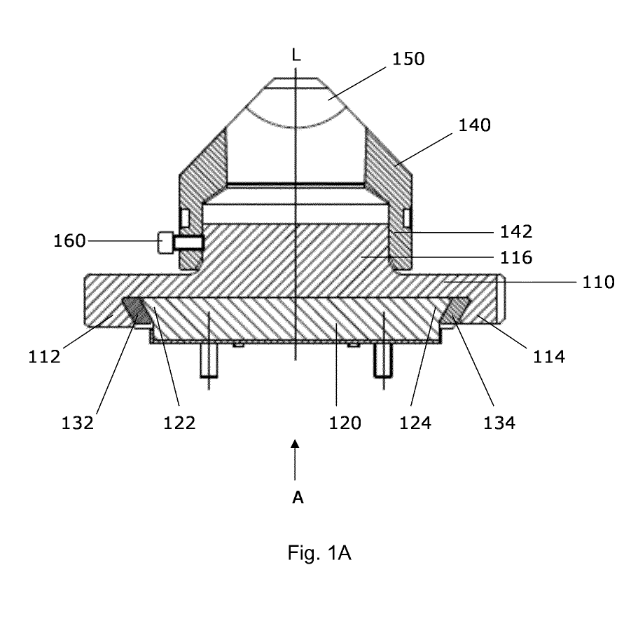

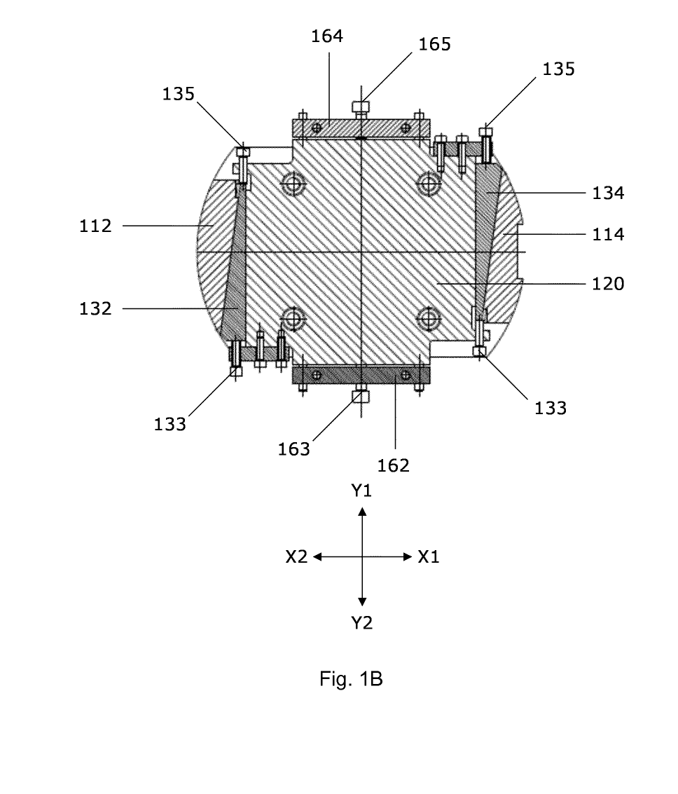

FIG. 1A shows a longitudinal cross section view of an example adjustment assembly arranged for moveably coupling an example platform to an example base;

FIG. 1B shows a bottom view of the example adjustment assembly shown in FIG. 1A from the perspective A;

With reference to FIG. 1A and FIG. 1B, an example adjustment assembly for a press system comprises a platform 110 coupled to a base 120, and a pair of taper gib deflection members 132, 134. The adjustment assembly is configured so that the taper gibs 132, 134 can urge the platform 110 to move laterally in a first direction X1 or X2 relative to the base 120, responsive to the taper gibs 132, 134 being simultaneously urged in the direction Y1 or Y2. In this example arrangement, second directions Y1 and Y2 are substantially orthogonal to the first directions X1 and X2. The platform 110 comprises an abutment surface that abuts a support surface of the base 120 and can slide against the support surface, both the abutment surface and the support surface being substantially planar. The taper gibs 132, 134 are located between respective parts 122, 124 of the base 120 and respective parts of the platform 112, 114, arranged such that the deflection members are canted at an angle of about 60 degrees to the longitudinal axis L. The taper gibs 132, 134 are arranged to be able to cooperate in adjusting the position of the platform 110 relative to the base 120. With reference to FIG. 1B, the example adjustment assembly further comprises a pair of transverse adjustment members 163, 165 arranged substantially orthogonal to the deflection members 132, 134 and capable of moving the platform laterally direction Y1 and Y2. In this particular arrangement, the transverse adjustment members 163, 165 are threaded bolts held by means of respective housings 162, 164 provided with threaded through-holes for the bolts 163, 165, the housings 162, 164 being attached to the base 120.

The example assembly illustrated in FIG. 1A further comprises an anvil 150 mounted onto an anvil holder 140, in which the anvil holder is rotatably coupled to the platform 110. The anvil holder 140 comprises an annular skirt 142 and the platform 110 comprises a projection 116 having a generally cylindrical outer side surface. The skirt 142 and the projection 116 are cooperatively configured so that the skirt 142 abuts the projection 116 and can slideably rotate about it. The anvil holder 140 is provided with a screw mechanism 160 as a means for fastening the anvil holder 140 in place or releasing it so that it is free to be rotated. The rotational adjustment mechanism is independent from the lateral adjustment, thus permitting the anvil to be independently aligned rotationally and laterally.

In use, the lateral position of the platform 110 relative to the base can be adjusted in directions X1 or X2 and Y1 or Y2 by coordinated action of the deflection members 132, 134 and or transverse adjustment members 163, 165. The position of the platform can be adjusted along both the first axis X1-X2 and the second axis Y1-Y2 simultaneously or sequentially. To move the platform 110 in the direction X1, the deflection members 132, 134 will be simultaneously moved in the direction Y1. To move the platform 110 in the direction X2, the deflection members 132, 134 will be simultaneously moved in the direction Y2. To move the platform in the direction Y1, the transverse adjustment members 163, 165 will be moved simultaneously in the same direction Y1, and to move the platform in the direction Y2, the transverse adjustment members 163, 165 will be moved simultaneously in the same direction Y2. The deflection members 132, 134 can be actuated by operation of adjustment bolts 133, 135. The platform 110 can be secured in place by tightening both sets of adjustment/lock bolts 133, 135.

The adjustment mechanism may comprise an X-Y positioning table arrangement, in which the abutment surface may be mounted on ball bearing slides or roller slides, which may have with multiple linear bases and comprise a forcer and a platen. The forcer may glide over the platen on a substantially frictionless air bearing and move continuously in a substantially linear motion across the platen. To provide more than one axis, linear bases may be stacked on top of one another, with a top “Y” axis acting both as a carriage to the bottom base and as the base which holds the table. Adjustable gibs may be attached on both axes.

1-13. (canceled)

14. A press apparatus suitable for generating ultra-high pressure, comprising at least two load assemblies attached to a press frame, arranged to be capable of cooperatively generating an applied load on a reaction volume, and each comprising an adjustment assembly comprising:
a platform moveably coupled to a base comprising a ram of a hydraulic cylinder; and
an adjustment mechanism comprising a pair of deflection members for adjusting the position of the platform laterally relative to the base; the base comprising a pair of base contact surfaces, the platform comprising a pair of platform contact surfaces, each abutting a respective deflection member; each deflection member accommodated between respective platform and base contact surfaces;
an anvil member coupled to each platform;
the adjustment assembly being configured so that the platform is capable of being urged to move laterally in a direction along a first axis responsive to the deflection members being urged to move in a direction along a second axis, the second axis being not parallel to the first direction; in which the platform and base contact surfaces are configured such that the deflection members are canted in relation to a lateral plane defined by the first and second axes.

15. A press apparatus as claimed in claim 14, in which the deflection members are canted at an angle of at least 50 degrees and at most 65 degrees to the lateral plane.

16. A press apparatus as claimed in claim 14, in which the anvil member is moveably coupled to the platform by means of an adjustment assembly configured to permit rotational movement of the anvil member relative to the platform.

17. A press apparatus as claimed in claim 15, in which the anvil member is moveably coupled to the platform by means of an adjustment assembly configured to permit rotational movement of the anvil member relative to the platform.

18. A press apparatus as claimed in claim 14, in which the first and second axes are orthogonal.

19. A press apparatus as claimed in claim 14, in which each of the deflection members each comprise a tapered wedge portion, the platform and the base being cooperatively configured to accommodate each wedge portion between them so that movement of one of the deflection members in a direction along the second axis urges the platform to move relative to the base along the first axis, and simultaneous movement of the other deflection member in the same direction along the second axis permits movement of the base in the direction.

20. A press apparatus as claimed in claim 14, comprising a pair of transverse adjustment members arranged to be capable of moving the platform relative to the base along the second axis, responsive to the transverse adjustment members being urged along the second axis.

21. A press apparatus as claimed in claim 20, in which the transverse adjustment members are arranged to function as a guide mechanism for the platform when it is being moved along the first axis responsive to movement of the deflection members.

22. A press apparatus as claimed in claim 20, in which the deflection members are arranged to function as a guide mechanism for the platform when it is being moved along the second axis responsive to movement of the transverse adjustment members.

23. A press apparatus as claimed in claim 20, in which the platform comprises a first pair of opposite contact surfaces, each abutting a respective deflection member, and a second pair of opposite contact surfaces, each abutting a respective transverse adjustment member; the first and second pairs of contact surfaces being orthogonal to each other.
